(19) United States
(12) Patent Application Publication
(10) Pub. No.: US 2006/0268658 A1
(43) Pub. Date: Nov. 30, 2006

(54) Computational flow dynamics investigation of mixing within an industrial-scale gear pump

(76) Inventors: Wayne Scott Strasser, Kingsport, TN (US); Bruce Roger DeBruin, Lexington, SC (US)

Correspondence Address: Dennis V. Carmen;Eastman Chemical Company, P.O. Box 511, Kingsport, TN, 37662-5075, US

(21) Appl. No.: 11/139,410

(22) Filed: May 27, 2005

(51) Int. Cl. B01F 5/14

(52) U.S. Cl. 366/272

(57) ABSTRACT

A method of mixing fluids includes providing a flow stream of a first fluid, providing a flow stream of second fluid, and providing a gear pump having an inlet and an outlet. The flow stream of the first fluid and the second fluid is fed through the inlet of the gear pump. The gear pump is operated to mix the flow stream of the first fluid and the second fluid to obtain a mixed fluid flow stream out of the outlet of the gear pump.

### FIELD OF THE INVENTION

The present invention relates generally to fluid material mixing processes. More particularly, the present invention relates to utilizing processing equipment to mix materials of various viscosities to achieve an acceptable level of mixing in laminar flow processes.

### BACKGROUND OF THE INVENTION

Mixing is central to a vast majority of processes including, for example(s), the chemical, pharmaceutical, food, water, and polymer processing industries. Processing equipment has been relied upon for facilitating mixing operations in order to generate desired mixes of materials. One example of processing equipment may include the use of static mixers within the aforementioned industries.

Static mixers have been commonly utilized, for example(s), within the food processing and/or polymer processing industries for mixing fluid materials. Such fluid flow materials may further posses various viscous properties. Thus, it may be desirable to mix two or more viscous materials, for instance, in a laminar flow procedure. It may be further desirable to achieve a degree of mixture of combined viscous materials.

One way to measure the degree of mixture includes measuring a coefficient of variation (COV) (which is the standard deviation divided by the time-averaged mass flow-weighted area averaged mass concentration (MFWAA)) measured at a prescribed point such as at the outlet of the static mixer. In addition, a degree of homogeneity of mixed fluid materials may be measured from a determination of the coefficient of variation results. In one example, an otherwise desirable measurement of the coefficient of variation (COV) at the output of a static mixer may be around 5%. This would tend to produce a homogeneous mixture of approximately 95%. However, the aforementioned production of mixed homogenous material(s) as a result of utilizing the static mixer, while otherwise desirable, may also generate additional difficulties by employing such static mixers within a laminar flow mixing operation.

For example, procurement expenses are associated with obtaining static mixers to employ in fluid processing operations/industries. Additionally, when utilized in a typical mixing operation, static mixers may also be inclined to impede the flow of the materials being mixed. Thus, in order to address restriction(s) to flow, a process has been developed which may incorporate one or more pumps in line with the static mixer in an effort to overcome an impedance of flow. However, the additional costs associated with providing supplemental equipment (such as the aforementioned pumps) can drive up the overall costs required to produce a preferred entire mixing assembly.

It is accordingly a primary object of the invention to provide a method and apparatus that can reduce an amount of additional equipment and/or associated expense(s) required to obtain an acceptable level of mixing materials in laminar flow processes.

### SUMMARY OF THE INVENTION

The foregoing needs are met, to a great extent, by the present invention, wherein in one aspect a method of mixing fluids is provided that in some embodiments comprises providing a flow stream of a first fluid, providing at least one flow stream of a second fluid, and providing a gear pump having an inlet and an outlet. The method may also provide feeding the flow stream of the first fluid and the at least one flow stream of the second fluid through the inlet of the gear pump. Thus, the gear pump may be operated to mix the flow stream of the first fluid and the at least one flow stream of the second fluid to obtain a mixed fluid flow stream out of the outlet of the gear pump. The method may also include providing multiple flow streams of the second fluid and feeding the flow stream of the first fluid and the multiple flow streams of the second fluid through the inlet of the gear pump. Thus, the gear pump may be operated to mix the flow stream of the first fluid and the multiple flow streams of the second fluid to obtain a mixed fluid flow stream out of the outlet of the gear pump.

Additional objects and advantages of the invention will be set forth in part in the description which follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

The accompanying drawings, which are incorporated in and constitute a part of this specification, illustrate one (several) embodiment(s) of the invention and together with the description, serve to explain the principles of the invention.

### BRIEF DESCRIPTION OF THE DRAWINGS

FIG. 1 is a cross-sectional view illustrating a single additive inlet feed according to a preferred embodiment of the invention.

FIG. 2 is a cross-sectional view illustrating multiple additive inlet feeds according to a preferred embodiment of the invention.

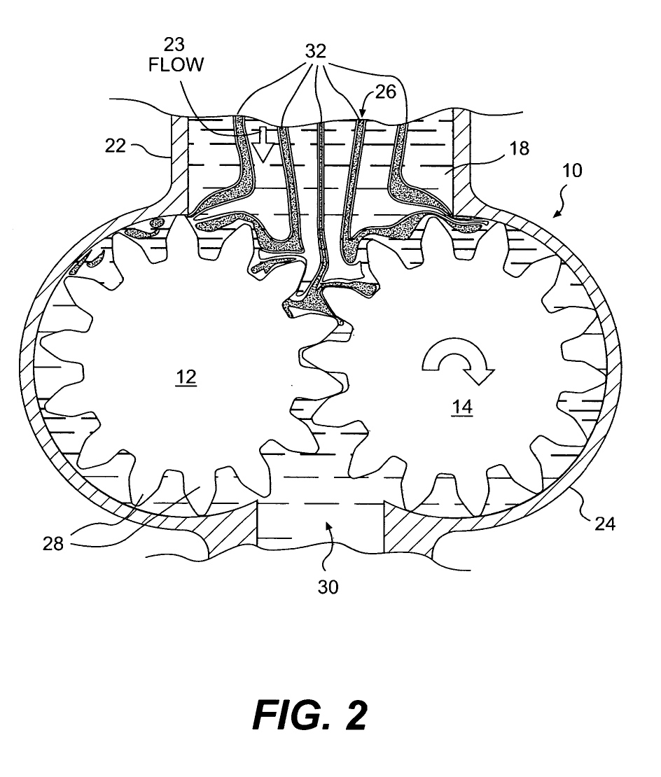

FIG. 3 is an enlarged view of the gear assembly shown in FIG. 1.

### DESCRIPTION OF THE EMBODIMENTS

The invention in some preferred embodiments provides a method for mixing fluids to achieve an acceptable level of mixed materials in a laminar flow process. In a preferred embodiment, the invention utilizes unsteady, laminar, multiphase flow of a mixture of viscous materials through an intermeshing industrial-scale gear pump. The unsteady, laminar, multiphase flow of a mixture of viscous materials utilized by the invention may be employed within one of many processing industries including, for examples, chemical, pharmaceutical, food, water, and polymer processing industries. Reference will now be made in detail to the present embodiment(s) (exemplary embodiments) of the invention, an example(s) of which is (are) illustrated in the accompanying drawings. Wherever possible, the same reference numbers will be used throughout the drawings to refer to the same or like parts.

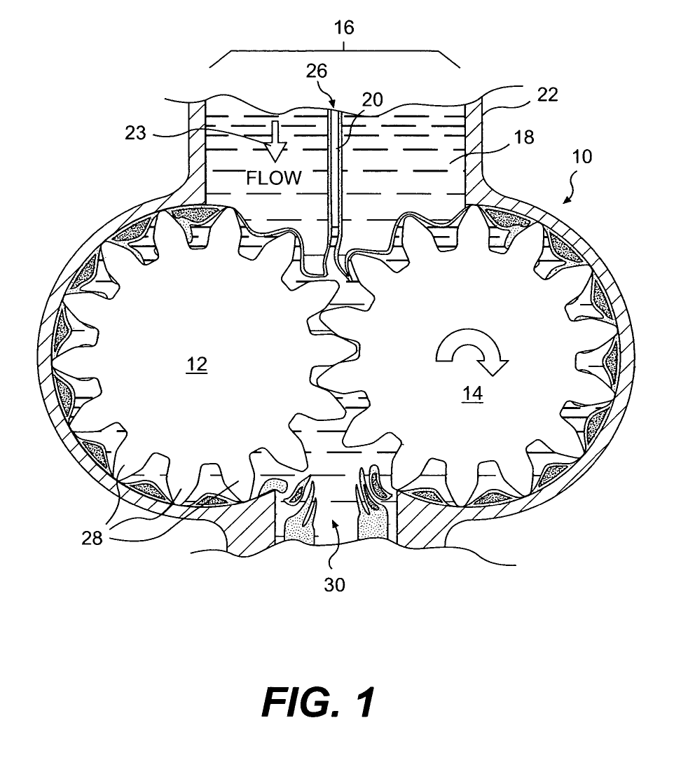

FIG. 1 illustrates a cross-sectional view of an exemplary industrial-scale gear pump assembly receiving a mixture of viscous materials 16 such as one comprising a first fluid 18 and a second fluid 20. In a preferred embodiment, the mixture of viscous materials 16 may travel through a containment means, such as a pipe assembly 22. The mixture of viscous materials 16 may also flow at a prescribed flow rate and in a general flow direction 23 preferably towards an inlet region 26 of the industrial-scale gear pump assembly 10.

The industrial-scale gear pump assembly 10 may include one of many variations of gear pumps such as one having two intermeshing gears. The industrial-scale gear pump may also be referred to as a positive displacement or metering gear pump. This positive displacement or metering pump may use two intermeshing gears which rotate in opposite directions. The orientation of the two gear pump axis is fixed, i.e., one gear does not rotate around the other gear. In a preferred embodiment, a gear pump may be utilized consisting of a plurality of cooperating gears such as two spur gears meshing together and revolving in opposite directions. The cooperating gears may comprise a first gear 12 and a second gear 14. In one embodiment, the first gear 12 and the second gear 14 may be located within a housing assembly such as a casing 24. A plurality of gear teeth 28 may also be disposed on each of the first gear 12 and the second gear 14. In final assembly, a clearance exists between the casing 24 and the gear teeth 28 located respectively on each of the first gear 12 and the second gear 14.

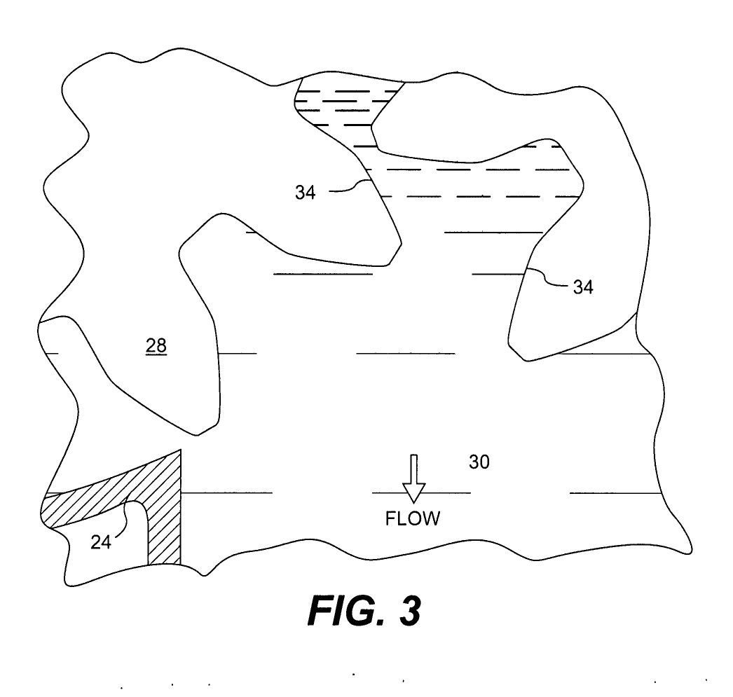

Turning to FIG. 3, various clearances also exist between the faces 34 of the gear teeth 28 disposed on the cooperating gears including first gear 12 and second gear 14. Such clearance tolerances may be on an order of only a few thousandths of an inch clearance between the casing 24 and the extremities of the faces 34 of the gear teeth 28. Thus, any fluid that fills the space bounded by two successive gear teeth 28 and the casing 24 can follow along with the gear teeth 28 as they revolve. When the gear teeth 28 of the first gear 12 mesh with the gear teeth 28 of the second gear 14, the space between the teeth 28 is reduced, and the entrapped fluid is forced out the pump through an outlet region 30. As the first gear 12 and the second gear 14 revolve and the gear teeth 28 disengage, the space between the gear teeth 28 opens to effectively create a suction force generally located at the inlet region 26 of the pump trapping new quantities of fluid. As fluid is carried away from the suction created generally at the inlet region 26, a lower pressure is created, which can draw additional fluid in through the inlet region 26.

The invention provides a laminar flow stream of a first fluid 18 (otherwise acting as a process fluid) which is fed into the inlet region 26 of the industrial-scale gear pump assembly 10. A pipe assembly 22 may be utilized to feed the first fluid material 18 into the inlet region 26. In one embodiment, a flow stream of a second fluid 20, such as an additive, is provided and is also fed into the inlet region 26 of the industrial-scale gear pump assembly 10. The second fluid 20 can be allowed to flow through the flow stream of the first fluid 18 prior to entering the inlet region 26. The second fluid 20 may also be fed within the aforementioned pipe assembly 22, for example, through the first fluid material 18 and into the inlet region 26.

As previously mentioned, the invention may be practiced in a wide variety of industries requiring mixing processes such as chemical, pharmaceutical, food, water, and polymer processing industries. Accordingly, the first fluid 18 is preferably a process fluid including liquids having a viscosity which is one to two orders of magnitude larger than the viscosity of the second fluid 20. An example of the aforementioned process fluid may include polymers including, for examples, polyesters, polyamides, polyurethanes, polyolefins and poly(ethylene terephthalate) or a copolymer thereof. Thus, the second fluid 20 or additive is preferably fed at relatively low mass concentrations (5% or greater by weight of the flow stream of the first fluid 18) within the flow stream of the first fluid material and/or into the inlet region 26 of the industrial-scale gear pump assembly 10.

A preferred composition of the second fluid 20 includes essentially those selected from pure additives including liquids. An example of materials which may be utilized as an additive includes a colorant, a pigment, a carbon black, a glass fiber, an impact modifier, an antioxidant, a surface lubricant, a denesting agent, a UV light absorbing agent, a metal deactivator, filler, a nucleating agent, a stabilizer, a flame retardant, a reheat aid, a crystallization aid, an acetaldehyde reducing compound, a recycling release aid, an oxygen scavenging material, a platelet particle, amino acids, glycerin lower fatty acid esters, sugar esters, salts of vitamin B1, polyphosphates, ethanol, basic proteins and peptides, antibacterial extract from licorice, extract from red pepper, extract from hop, extract from yucca, extract from moso bamboo (thick-stemmed bamboo), extract from grape fruit seed, extract from wasabi (Japanese horseradish) or mustard, acetic acid, lactic acid, fumaric acid and the salts thereof, sorbic acid, benzoic acid and the salts and esters thereof, propionic acid and the salt thereof, chitosan and bacterium DNA, cyclohexane dimethanol, trimellitic anhydryde and other cross-linking agents, and a mixture thereof.

As power is applied to the industrial-scale gear pump assembly 10, the first gear 12 and second gear 14 rotate in intermeshing fashion. Hence, an unsteady, laminar, multiphase flow of a mixture of viscous materials comprising the first fluid 18 and the second fluid 20 is created. As the flow stream comprising the first fluid 18 and the flow stream of the second fluid 20 enters the inlet region 26 of the industrial-scale gear pump assembly 10, a mixing of the first fluid 18 and the second fluid 20 occurs around and throughout the region of intermeshing first gear 12 and second gear 14. The outlet region 30 of the industrial-scale gear pump assembly 10 produces a degree of a mixed fluid flow stream comprising the first fluid 18 and the second fluid 20. As the viscosity ratio between the first fluid 18 and the second fluid 20 approaches unity (one) the degree of mixing may be improved. The aforementioned degree of mixing produces a coefficient of variation (COV) of 35% or less measured at the outlet region 30 of the industrial-scale gear pump assembly 10.

In an alternate embodiment, the additive of the second fluid 20 may comprise multiple flow streams of the second fluid 32. Turning to FIG. 3, the multiple flow streams of the second fluid 32 is provided and is also fed into the inlet region 26 of the industrial-scale gear pump assembly 10. The multiple flow streams of the second fluid 32 may also flow through the flow stream of the first fluid 18 prior to entering the inlet region 26. The multiple flow streams of the second fluid 32 may also traverse the aforementioned pipe assembly 22, for example, through the first fluid material 18 and into the inlet region 26.

Again, as power is applied to the industrial-scale gear pump assembly 10, the first gear 12 and second gear 14 rotate in intermeshing fashion. Hence, an unsteady, laminar, multiphase flow of a mixture of viscous materials comprising the first fluid 18 and the multiple flow streams of the second fluid 32 is created. As the flow stream comprising the first fluid 18 and the multiple flow streams of the second fluid 32 enter the inlet region 26 of the industrial-scale gear pump assembly 10, a mixing of the first fluid 18 and the multiple flow streams of the second fluid 32 occurs around and throughout the region of intermeshing first gear 12 and second gear 14. The outlet region 30 of the industrial-scale gear pump assembly 10 produces a degree of a mixed fluid flow stream comprising the first fluid 18 and the multiple flow streams of the second fluid 32. The degree of mixing the first fluid 18 and the multiple flow streams of the second fluid 32 in accordance with an embodiment of the invention produces a coefficient of variation (COV) of 1.3% or less measured at the outlet region 30 of the industrial-scale gear pump assembly 10.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A method of mixing fluids comprising:
providing a flow stream of a first fluid;
providing at least one flow stream of a second fluid;
providing a gear pump having an inlet and an outlet;
feeding the flow stream of the first fluid and the at least one flow stream of the second fluid through the inlet of the gear pump;
operating the gear pump to mix the flow stream of the first fluid and the at least one flow stream of the second fluid to obtain a mixed fluid flow stream out of the outlet of the gear pump.

2. A method of claim 1, further comprising:
providing the at least one flow stream of the second fluid through the flow stream of the first fluid before feeding the stream through the inlet of the gear pump.

3. The method of claim 1, wherein the at least one flow stream of the second fluid is fed generally along the center line of the flow stream of the first fluid into the inlet of the gear pump.

4. The method of claim 1, wherein the viscosity of the of the first fluid is different from the viscosity of the second fluid.

5. The method of claim 4, wherein the viscosity of the first fluid is higher than the viscosity of the second fluid.

6. The method of claim 1, wherein the second fluid comprises an additive selected from a colorant, pigment, carbon black, glass fiber, impact modifier, antioxidant, surface lubricant, denesting agent, UV light absorbing agent, metal deactivator, filler, nucleating agent, stabilizer, flame retardant, reheat aid, crystallization aid, acetaldehyde reducing compound, recycling release aid, oxygen scavenging material, platelet particle, amino acids, glycerin lower fatty acid esters, sugar esters, salts of vitamin B1, polyphosphates, ethanol, basic proteins and peptides, antibacterial extract from licorice, extract from red pepper, extract from hop, extract from yucca, extract from moso bamboo (thick-stemmed bamboo), extract from grape fruit seed, extract from wasabi (Japanese horseradish) or mustard, acetic acid, lactic acid, fumaric acid and the salts thereof, sorbic acid, benzoic acid and the salts and esters thereof, propionic acid and the salt thereof, chitosan and bacterium DNA, cyclohexane dimethanol, trimellitic anhydryde and other cross-linking agents, and a mixture thereof.

7. The method of claim 1, wherein the first fluid comprises a polymer selected from polyesters, polyamides, polyurethanes, polyolefins and poly(ethylene terephthalate) or a copolymer thereof.

8. The method of claim 1, wherein the gear pump is operated to produce a mixed fluid flow stream having a coefficient of variation (COV) of 35% or less measured at the outlet of the pump.

9. The method of claim 1, wherein the first fluid and the second fluid each consist of a liquid.

10. The method of claim 1, wherein the at least one flow stream of the second fluid is fed into the flow stream of the first fluid at a rate of about 5 percent or greater by weight of the flow stream of the first fluid.

11. The method of claim 1, further comprising:
providing multiple flow streams of the second fluid;
feeding the flow stream of the first fluid and the multiple flow streams of the second fluid through the inlet of the gear pump;
operating the gear pump to mix the flow stream of the first fluid and the multiple flow streams of the second fluid to obtain a mixed fluid flow stream out of the outlet of the gear pump.

12. A method of claim 11, further comprising:
providing the multiple flow streams of the second fluid through the flow stream of the first fluid before feeding the stream through the inlet of the gear pump.

13. The method of claim 11, further comprising:
feeding the multiple flow streams of the second fluid into the gear pump in spaced apart feed streams.

14. The method of claim 13, further comprising:
symmetrically aligning the feed streams around the center line of the flow stream of the first fluid.

15. The method of claim 13, wherein the viscosity of the first fluid is different from the viscosity of the second fluid.

16. The method of claim 15, wherein the viscosity of the first fluid is higher than the viscosity of the second fluid.

17. The method of claim 11, wherein the multiple flow streams of the second fluid comprises an additive selected from a colorant, pigment, carbon black, glass fiber, impact modifier, antioxidant, surface lubricant, denesting agent, UV light absorbing agent, metal deactivator, filler, nucleating agent, stabilizer, flame retardant, reheat aid, crystallization aid, acetaldehyde reducing compound, recycling release aid, oxygen scavenging material, platelet particle, amino acids, glycerin lower fatty acid esters, sugar esters, salts of vitamin B1, polyphosphates, ethanol, basic proteins and peptides, antibacterial extract from licorice, extract from red pepper, extract from hop, extract from yucca, extract from moso bamboo (thick-stemmed bamboo), extract from grape fruit seed, extract from wasabi (Japanese horseradish) or mustard, acetic acid, lactic acid, fumaric acid and the salts thereof, sorbic acid, benzoic acid and the salts and esters thereof, propionic acid and the salt thereof, chitosan and bacterium DNA, cyclohexane dimethanol, trimellitic anhydryde and other cross-linking agents, and a mixture thereof.

18. The method of claim 11, wherein the first fluid comprises a polymer selected from polyesters, polyamides, polyurethanes, polyolefins and poly(ethylene terephthalate) or a copolymer thereof.

19. The method of claim 11, wherein the gear pump is operated to produce a mixed fluid flow stream having a coefficient of variation (COV) of 1.3% or less measured at the outlet of the pump.

20. The method of claim 11, wherein the first fluid and the second fluid each consist of a liquid.

21. The method of claim 11, wherein the multiple flow streams of the second fluid are fed into the flow stream of the first fluid at a rate of about 5 percent or greater by weight of the flow stream of the first fluid.
